(19) United States
(12) Patent Application Publication
(10) Pub. No.: US 2016/0161722 A1
(43) Pub. Date: Jun. 9, 2016

(54) IMAGING LENS

(71) Applicant: CALIN TECHNOLOGY CO., LTD., Taichung City (TW)

(72) Inventors: Shu-Chuan HSU, Taichung City (TW); JE-YI HUANG, YUNLIN COUNTY (TW)

(73) Assignee: CALIN TECHNOLOGY CO., LTD., Taichung City (TW)

(21) Appl. No.: 14/601,835

(22) Filed: Jan. 21, 2015

(30) Foreign Application Priority Data
Dec. 8, 2014 (TW) 103142579

(51) Int. Cl. G02B 13/18

(52) U.S. Cl. CPC G02B 13/18

(57) ABSTRACT

An imaging lens includes an aperture and a first to a fifth lenses in order from an object side to an image side. The first lens is a positive meniscus lens made of glass, which has at least one aspheric surface. The Abbe number of the first lens is no less than 60. The second lens is a negative meniscus lens made of plastic, which has at least one aspheric surface. The third lens is a positive meniscus lens made of plastic, which has at least one aspheric surface. The fourth lens is a positive meniscus lens made of plastic, which has at least one aspheric surface. The fifth lens is a negative lens made of plastic, and both surfaces thereof are aspherical. A diopter of the fifth lens gradually turns from negative to positive from where an optical axis passes through to a margin thereof.

The current application claims a foreign priority to the patent application of Taiwan No. 103142579 filed on Dec. 8, 2014.

### BACKGROUND OF THE INVENTION

1. Technical Field

The present invention relates generally to optics, and more particularly to an imaging lens.

2. Description of Related Art

With the recent development of mobile devices, the market demand for lens modules rises. In consideration of convenience and portability, the market prefers mobile devices to be miniature and lightweight, and as a result, various industries such as automotive industry, video game industry, household appliances industry, etc. also start using miniature optical module to develop more convenient functions.

It's needless to say that the size of the imaging lenses applied in miniature mobile devices is also greatly reduced in recent years, and since customers would like the image resolution of photos taken by such mobile devices to be satisfying high, the imaging lenses must be able to provide high optical performance. Therefore, miniature size and high optical performance are two key requirements for imaging lenses in modern days.

In addition, the imaging lenses applied in mobile devices nowadays are getting wide angle; however, a wide angle system often has problems of limited view angle, distortion, and chromatic aberration, which affects the output image quality. In light of this, there is still room for improvement for the design of imaging lenses.

### BRIEF SUMMARY OF THE INVENTION

In view of the above, the primary objective of the present invention is to provide an imaging lens which satisfies the requirements of miniature size, high optical performance, and wider view angle for a wide angle system.

The present invention provides an imaging lens, which includes, in order from an object side to an image side along an optical axis, an aperture, a first lens, a second lens, a third lens, a fourth lens, and a fifth lens. The first lens is made of glass, and is a positive meniscus lens, wherein a convex surface thereof faces the object side, and a concave surface thereof faces the image side; at least one of the surfaces of the first lens is aspheric; an Abbe number of first lens is no less than 60. The second lens is made of plastic, and is a negative meniscus lens, wherein a convex surface thereof faces the object side, and a concave surface thereof faces the image side; at least one of the surfaces of the second lens is aspheric. The third lens is made of plastic, and is a positive meniscus lens, wherein a convex surface thereof faces the image side, and a concave surface thereof faces the object side; at least one of the surfaces of the third lens is aspheric. The fourth lens is made of plastic, and is a positive meniscus lens, wherein a convex surface thereof faces the image side, and a concave surface thereof faces the object side; at least one of the surfaces of the fourth lens is aspheric. The fifth lens is made of plastic, and both surfaces thereof are aspheric; a diopter of the fifth lens gradually turns from negative to positive from where the optical axis passes through to a margin of the fifth lens.

In an embodiment, both surfaces of the first lens are aspheric.

In an embodiment, both surfaces of the second lens are aspheric.

In an embodiment, both surfaces of the third lens are aspheric.

In an embodiment, both surfaces of the fourth lens are aspheric.

In an embodiment, the surface of the fifth lens which faces the object side is concave at where the optical axis passes through; a radius of curvature of the surface of the fifth lens which faces the object side is negative at where the optical axis passes through, and gradually turns from negative to positive from where the optical axis passes through to the margin of the fifth lens.

In an embodiment, the surface of the fifth lens which faces the object side is convex at where the optical axis passes through; a radius of curvature of the surface of the fifth lens which faces the object side is positive at where the optical axis passes through, and gradually turns from positive to negative and positive again from where the optical axis passes through to the margin of the fifth lens.

In an embodiment, a surface of the fifth lens which faces the image side is concave at where the optical axis passes through; a radius of curvature of the surface of the fifth lens which faces the image side is p positive at where the optical axis passes through, and the radius of curvature gradually turns from positive to negative from where the optical axis passes through to the margin of the fifth lens.

In an embodiment, the imaging lens further satisfies: 0.74≦f1/f≦0.85; where f1 is a focal length of the first lens; f is a focal length of the imaging lens.

In an embodiment, the imaging lens further satisfies: −1.6≦f2/f≦−1.3; where f2 is a focal length of the second lens; f is a focal length of the imaging lens.

In an embodiment, the imaging lens further satisfies: 3.8≦f3/f≦5.1; where f3 is a focal length of the third lens; f is a focal length of the imaging lens.

In an embodiment, the imaging lens further satisfies: 0.75≦f4/f≦0.96; where f4 is a focal length of the fourth lens; f is a focal length of the imaging lens.

In an embodiment, the imaging lens further satisfies: −0.70≦f5/f≦−0.54; where f5 is a focal length of the fifth lens; f is a focal length of the imaging lens.

In an embodiment, the imaging lens further satisfies: 1.16≦TTL/f≦1.20; where f is a focal length of the imaging lens; TTL is a total length of the image lens.

In an embodiment, the imaging lens further satisfies: 0.69≦IMH/TTL≦0.78; where IMH is a height of an imaging plane of the imaging lens; TTL is a total length of the image lens.

In an embodiment, the imaging lens further satisfies: 1.9≦f1/R1≦2.2; where f1 is a focal length of the first lens; R1 is a radius of curvature of the surface of the first lens which faces the object side at where the optical axis passes through.

With the aforementioned structure and materials of the lenses, the purpose of getting miniature size and high optical performance can be achieved. In addition, the visible angle of a wide angle system can be effectively widened as well.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1 is a schematic diagram of a first preferred embodiment of the present invention;

FIG. 2A is a diagram showing the field curvature of the imaging lens of the first preferred embodiment of the present invention;

FIG. 2B is a diagram showing the distortion of the imaging lens of the first preferred embodiment of the present invention;

FIG. 2C is a diagram showing the spherical aberration of the imaging lens of the first preferred embodiment of the present invention;

FIG. 2D is a diagram showing the chromatic difference of magnification of the imaging lens of the first preferred embodiment of the present invention;

FIG. 3 is a schematic diagram of a second preferred embodiment of the present invention;

FIG. 4A is a diagram showing the field curvature of the imaging lens of the second preferred embodiment of the present invention;

FIG. 4B is a diagram showing the distortion of the imaging lens of the second preferred embodiment of the present invention;

FIG. 4C is a diagram showing the spherical aberration of the imaging lens of the second preferred embodiment of the present invention;

FIG. 4D is a diagram showing the chromatic difference of magnification of the imaging lens of the second preferred embodiment of the present invention;

FIG. 5 is a schematic diagram of a third preferred embodiment of the present invention;

FIG. 6A is a diagram showing the field curvature of the imaging lens of the third preferred embodiment of the present invention;

FIG. 6B is a diagram showing the distortion of the imaging lens of the third preferred embodiment of the present invention;

FIG. 6C is a diagram showing the spherical aberration of the imaging lens of the third preferred embodiment of the present invention;

FIG. 6D is a diagram showing the chromatic difference of magnification of the imaging lens of the third preferred embodiment of the present invention;

FIG. 7 is a schematic diagram of a fourth preferred embodiment of the present invention;

FIG. 8A is a diagram showing the field curvature of the imaging lens of the fourth preferred embodiment of the present invention;

FIG. 8B is a diagram showing the distortion of the imaging lens of the fourth preferred embodiment of the present invention;

FIG. 8C is a diagram showing the spherical aberration of the imaging lens of the fourth preferred embodiment of the present invention; and

FIG. 8D is a diagram showing the chromatic difference of magnification of the imaging lens of the fourth preferred embodiment of the present invention.

### DETAILED DESCRIPTION OF THE INVENTION

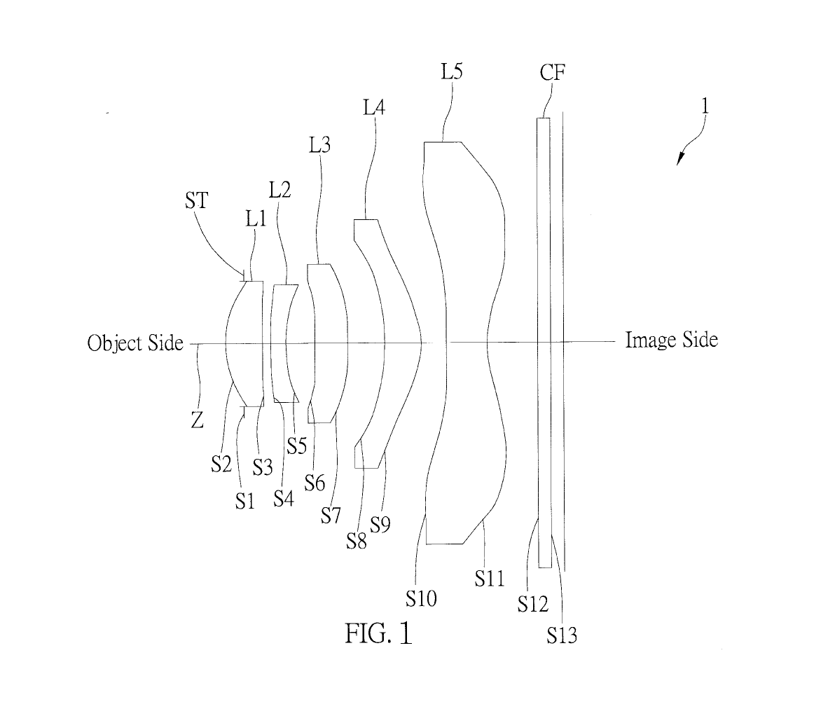

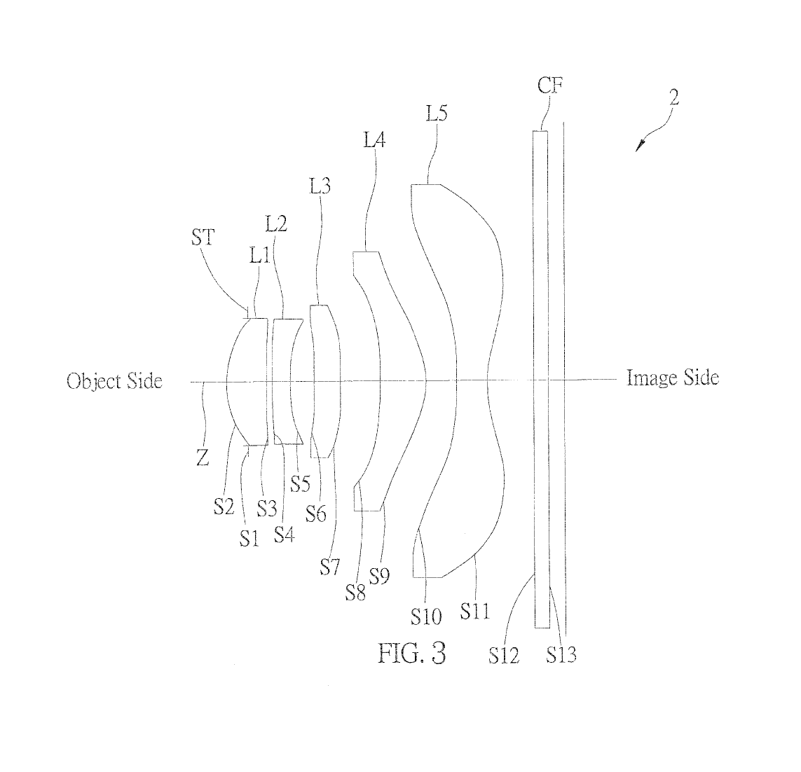

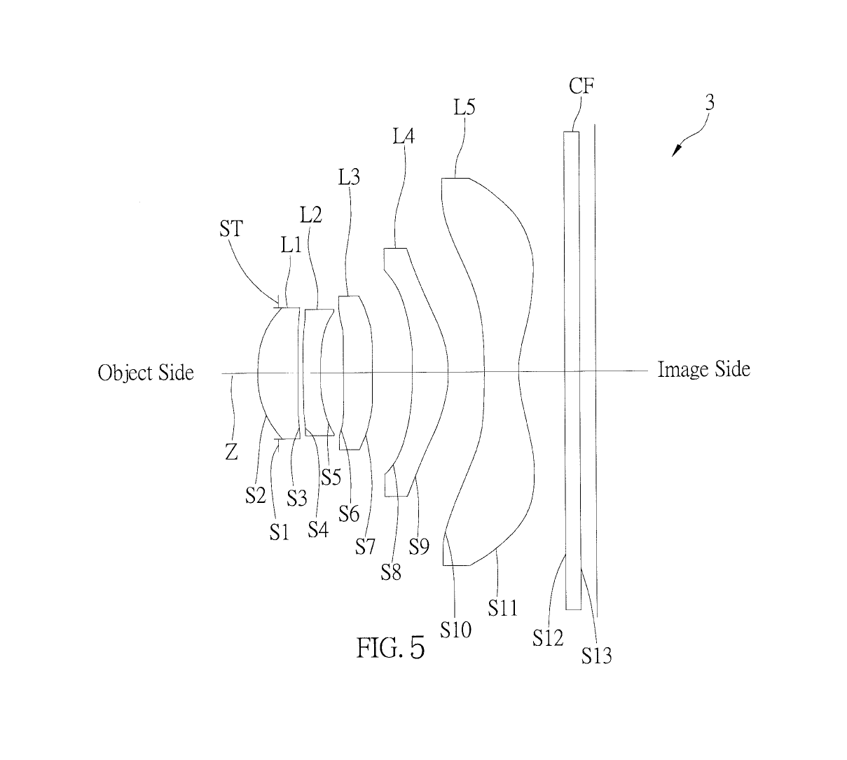

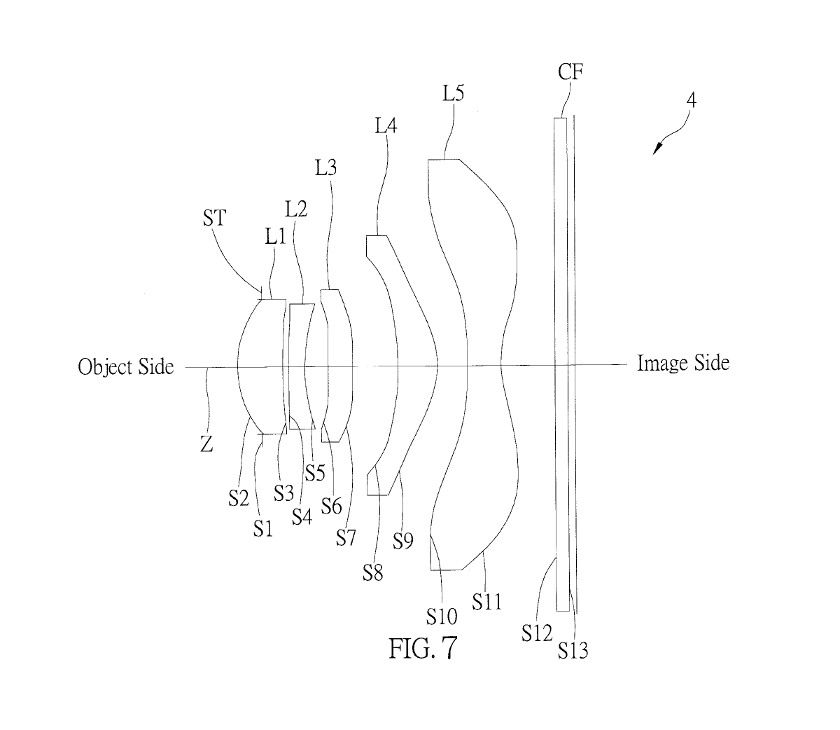

Image lenses 1-4 of the first to the fourth preferred embodiments of the present invention are respectively shown in FIG. 1, FIG. 3, FIG. 5, and FIG. 7. Each of the imaging lenses 1-4 includes, in order from an object side to an image side along an optical axis Z, an aperture ST, a first lens L1, a second lens L2, a third lens L3, a fourth lens L4, and a fifth lens L5, wherein a diopter of each lens L1-L5 is respectively positive, negative, positive, positive, and negative at where the optical axis goes through. Surfaces S2-S11 of the lenses L1-L5 are all aspheric. In addition, an optical filter CF is provided between the fifth lens L5 and the image side to filter out unwanted stray light if necessary, which helps to enhance optical performance.

In the imaging lenses 1-4 of the first to the fourth preferred embodiments of the present invention, the first lens L1 is a meniscus lens with the convex surface S2 facing the object side and the concave surface S3 facing the image side; the second lens L2 is a meniscus lens with the convex surface S4 facing the object side and the concave surface S5 facing the image side; the third lens L3 is a meniscus lens with the concave surface S6 facing the object side and the convex surface S7 facing the image side; the fourth lens L4 is a meniscus lens with the concave surface S8 facing the object side and the convex surface S9 facing the image side.

The difference between each preferred embodiment is about a radius of curvature of the fifth lens L5 at where the optical axis passes through. In the first preferred embodiment, the surface S10 of the fifth lens L5 of the imaging lens 1 which faces the object side is convex (i.e., the radius of curvature is positive) at where the optical axis passes through. Therefore, the radius of curvature of the surface S10 gradually turns from positive to negative and positive again from where the optical axis passes through to a margin of the fifth lens L5. The surface S11 of the fifth lens L5 of the imaging lens 1 which faces the image side is concave (i.e., the radius of curvature is negative) at where the optical axis passes through. Therefore, the radius of curvature of the surface S11 gradually turns from positive to negative from where the optical axis passes through to the margin of the fifth lens L5. Specifically, the surfaces S10, S11 are designed in a way that the diopter of the fifth lens L5 gradually turns from negative to positive from where the optical axis passes through to the margin of the fifth lens L5.

In the second, third, and fourth preferred embodiments, the surface S10 of the fifth lens L5 which faces the object side is concave (i.e., the radius of curvature is negative) at where the optical axis passes through. Therefore, the radius of curvature of the surface S10 gradually turns from negative to positive from where the optical axis passes through to a margin of the fifth lens L5. Similarly, the surfaces S10, S11 in these preferred embodiments are also designed in a way that the diopter of the fifth lens L5 gradually turns from negative to positive from where the optical axis passes through to the margin of the fifth lens L5.

The following Tables 1-4 respectively list a system focal length f of each of the imaging lenses 1-4 in the first to the fourth preferred embodiments, along with the radius of curvature R of each surface S2-S11 at where the optical axis Z passes through, a distance D between each surface S2-S11 and the next surface S2-S11 (or an imaging plane) along the optical axis Z, a material of each lens L1-L5, a refractive index Nd of each lens L1-L5, an Abbe number Vd of each lens L1-L5, and a focal length of each lens L1-L5. With these figures listed in Tables 1-4, the imaging lenses 1-4 of the first to the fourth preferred embodiments can effectively enhance optical performance.

TABLE 1
(the first preferred embodiment)
f = 4.60 mm

| | | | | | | Focal | |
|---|---|---|---|---|---|---|---|
| Surface | R (mm) | D (mm) | Material | Nd | Vd | Length | Component |
| S1 | ∞ | −0.2825728 | | | | | Aperture ST |
| S2 | 1.712824 | 0.5740615 | glass | 1.516 | 64.1 | 3.418 | First Lens L1 |
| S3 | 46.75763 | 0.1323232 | | | | | |
| S4 | 6.241833 | 0.25 | plastic | 1.642 | 22.4 | −6.381 | Second Lens L2 |
| S5 | 2.447412 | 0.4742351 | | | | | |
| S6 | −9.613208 | 0.518274 | plastic | 1.531 | 55.7 | 23.15 | Third Lens L3 |
| S7 | −5.504177 | 0.5868162 | | | | | |
| S8 | −3.180978 | 0.57529 | plastic | 1.531 | 55.7 | 3.96 | Fourth Lens L4 |
| S9 | −1.348511 | 0.4113892 | | | | | |
| S10 | 80.11441 | 0.6403799 | plastic | 1.531 | 55.7 | −2.849 | Fifth Lens L5 |
| S11 | 1.486164 | 0.8159251 | | | | | |
| S12 | ∞ | 0.21 | glass | 1.5163 | 64.1 | | Optical Filter CF |
| S13 | ∞ | 0.199182 | | | | | |

TABLE 2
(the second preferred embodiment)
f = 4.08 mm

| | | | | | | | |
|---|---|---|---|---|---|---|---|
| | | | | | | Focal | |
| Surface | R (mm) | D (mm) | Material | Nd | Vd | Length | Component |

| | | | | | | | |
|---|---|---|---|---|---|---|---|
| S1 | ∞ | −0.2937448 | | | | | Aperture ST |
| S2 | 1.515445 | 0.5496945 | glass | 1.516 | 64.1 | 3.14 | First Lens L1 |
| S3 | 19.5664 | 0.08711894 | | | | | |
| S4 | 9.096886 | 0.25 | plastic | 1.642 | 22.4 | −5.667 | Second Lens L2 |
| S5 | 2.587006 | 0.3660841 | | | | | |
| S6 | −29.49261 | 0.3622795 | plastic | 1.531 | 55.7 | 18.268 | Third Lens L3 |
| S7 | −7.350098 | 0.5733299 | | | | | |
| S8 | −3.709758 | 0.6293488 | plastic | 1.531 | 55.7 | 3.161 | Fourth Lens L4 |
| S9 | −1.226788 | 0.4465162 | | | | | |
| S10 | −13.71921 | 0.4204823 | plastic | 1.531 | 55.7 | −2.312 | Fifth Lens L5 |
| S11 | 1.368213 | 0.6633252 | | | | | |
| S12 | ∞ | 0.21 | glass | 1.516 | 64.1 | | Optical Filter CF |
| S13 | ∞ | 0.2259435 | | | | | |

TABLE 3
(the third preferred embodiment)
f = 4.13 mm

| | | | | | | Focal | |
|---|---|---|---|---|---|---|---|
| Surface | R (mm) | D (mm) | Material | Nd | Vd | Length | Component |
| S1 | ∞ | −0.2937448 | | | | | Aperture ST |
| S2 | 1.531015 | 0.5455172 | glass | 1.516 | 64.1 | 3.16 | First Lens L1 |
| S3 | 20.9112 | 0.08448909 | | | | | |
| S4 | 6.025987 | 0.25 | plastic | 1.642 | 22.4 | −5.55 | Second Lens L2 |
| S5 | 2.214615 | 0.3512173 | | | | | |
| S6 | −26.0582 | 0.4031397 | plastic | 1.531 | 55.7 | 17.649 | Third Lens L3 |
| S7 | −6.947832 | 0.5748782 | | | | | |
| S8 | −3.591832 | 0.5040297 | plastic | 1.531 | 55.7 | 3.93 | Fourth Lens L4 |
| S9 | −1.387571 | 0.5038518 | | | | | |
| S10 | −38.35617 | 0.4828769 | plastic | 1.531 | 55.7 | −2.85 | Fifth Lens L5 |
| S11 | 1.588758 | 0.6643534 | | | | | |
| S12 | ∞ | 0.21 | glass | 1.516 | 64.1 | | Optical Filter CF |
| S13 | ∞ | 0.2123471 | | | | | |

TABLE 4
(the fourth preferred embodiment)
f = 4.20 mm

| | | | | | | Focal | |
|---|---|---|---|---|---|---|---|
| Surface | R (mm) | D (mm) | Material | Nd | Vd | Length | Component |
| S1 | ∞ | −0.3572004 | | | | | Aperture ST |
| S2 | 1.63415 | 0.6660115 | glass | 1.514 | 63.3 | 3.54 | First Lens L1 |
| S3 | 13.17739 | 0.08 | | | | | |
| S4 | 7.71684 | 0.25 | plastic | 1.642 | 22.4 | −6.58 | Second Lens L2 |
| S5 | 2.714637 | 0.3454669 | | | | | |
| S6 | −32.75801 | 0.3620568 | plastic | 1.544 | 55.9 | 16.14 | Third Lens L3 |
| S7 | −6.977679 | 0.6659967 | | | | | |
| S8 | −3.811038 | 0.5840767 | plastic | 1.544 | 55.9 | 3.167 | Fourth Lens L4 |
| S9 | −1.254656 | 0.4463914 | | | | | |
| S10 | −9.844213 | 0.5 | plastic | 1.544 | 55.9 | −2.291 | Fifth Lens L5 |
| S11 | 1.460712 | 0.79 | | | | | |
| S12 | ∞ | 0.21 | glass | 1.516 | 64.1 | | Optical Filter CF |
| S13 | ∞ | 0.09661739 | | | | | |

In addition, for the lenses L1-L5 of the imaging lens 1-4 in the first to the fourth preferred embodiments, the surface concavities z of each aspheric surface S2-S11 is defined by the following formula:

$$z = \frac{{ch}^{2}}{1 + \sqrt{1 - ( 1 + k ) {c}^{2} {h}^{2}}} + {α}_{2} {h}^{4} + {α}_{3} {h}^{6} + {α}_{4} {h}^{8} + {α}_{5} {h}^{10} + {α}_{6} {h}^{12} + {α}_{7} {h}^{14} + {α}_{8} {h}^{16}$$

where:

z is the surface concavity;
c is the reciprocal of the radius of curvature;
h is half the off-axis height of the surface;
k is conic constant; and
α₂-α₈ respectively represents different order coefficient of h.

The conic constant k and each order coefficient α₂-α₈ of the imaging lenses 1-4 of the first to the fourth preferred embodiments of the present invention are respectively listed in the following Tables 5-8.

TABLE 5
(the first preferred embodiment)

| | Surface | | | | |
|---|---|---|---|---|---|
| | S2 | S3 | S4 | S5 | S6 |
| k | 5.9617E−01 | 0.0000E+00 | −8.8321E+00 | −2.9481E+00 | 2.8365E+01 |
| α₂ | −8.3308E−03 | 1.4134E−02 | −2.9099E−02 | −1.4534E−02 | −7.2833E−02 |
| α₃ | 6.2117E−03 | 5.7061E−03 | 4.5224E−02 | 6.8389E−02 | −2.2024E−02 |
| α₄ | −1.8983E−02 | 1.2890E−03 | −2.9620E−02 | −5.7993E−02 | 6.8094E−03 |
| α₅ | 1.9090E−02 | 5.0054E−03 | 3.3398E−03 | 4.3876E−02 | 4.7428E−03 |
| α₆ | 1.0265E−03 | −8.2726E−03 | 1.0722E−02 | 1.7635E−02 | −4.5471E−03 |
| α₇ | −1.5311E−02 | 9.1380E−03 | −1.0908E−02 | −3.8802E−02 | −8.0226E−03 |
| α₈ | 9.3208E−03 | −3.8935E−03 | 2.8963E−04 | 2.2571E−02 | 2.0204E−02 |
| | Surface | | | | |
| | S7 | S8 | S9 | S10 | S11 |
| k | −1.6192E+00 | −3.0815E−01 | −3.6278E+00 | 0.0000E+00 | −7.2273E+00 |
| α₂ | −4.4792E−02 | 4.7924E−02 | 7.0162E−04 | −5.6445E−02 | −3.4428E−02 |
| α₃ | −2.8886E−02 | −2.9412E−02 | 1.1146E−02 | 1.3456E−02 | 7.2546E−03 |
| α₄ | 2.3744E−03 | 3.9516E−03 | −4.4592E−03 | −1.0960E−03 | −1.1661E−03 |
| α₅ | 7.6584E−03 | −2.9983E−04 | 1.0441E−03 | −6.0624E−06 | 9.6667E−05 |
| α₆ | −2.1962E−03 | 9.5026E−05 | −7.1742E−05 | 5.6638E−06 | 4.3113E−06 |
| α₇ | −2.3912E−03 | 7.9551E−05 | −1.8552E−05 | −1.8855E−07 | 1.3449E−07 |
| α₈ | 2.3485E−03 | −2.8944E−05 | 1.8912E−06 | −5.4416E−09 | −2.9635E−09 |

TABLE 6
(the second preferred embodiment)

| | Surface | | | | |
|---|---|---|---|---|---|
| | S2 | S3 | S4 | S5 | S6 |
| k | 3.8381E−01 | −1.2681E+01 | −3.7909E−01 | −1.2993E+00 | 0.0000E+00 |
| α₂ | −9.8681E−03 | 9.6824E−03 | −2.6204E−02 | 1.0894E−03 | −7.8040E−02 |
| α₃ | 2.3450E−02 | 1.4713E−02 | 7.9711E−02 | 1.2514E−01 | −5.5834E−02 |
| α₄ | −5.2355E−02 | 1.8806E−02 | −7.5121E−02 | −1.6706E−01 | 1.2446E−02 |
| α₅ | 6.5775E−02 | 9.3284E−05 | −1.3632E−02 | 1.3391E−01 | 6.3134E−02 |
| α₆ | 1.5536E−02 | −7.9306E−02 | 5.4592E−02 | 1.0716E−01 | −2.6278E−02 |
| α₇ | −9.7962E−02 | 8.5861E−02 | −2.2319E−02 | −2.1875E−01 | −8.6017E−02 |
| α₈ | 6.3604E−02 | −2.2609E−02 | −2.2512E−02 | 1.1140E−01 | 1.0482E−01 |
| | Surface | | | | |
| | S7 | S8 | S9 | S10 | S11 |
| k | −5.3040E−01 | 2.8035E−02 | −3.7255E+00 | 1.8059E−01 | −7.3735E+00 |
| α₂ | −4.3371E−02 | 4.8188E−02 | −1.5804E−02 | −9.0459E−02 | −5.9372E−02 |
| α₃ | −6.6218E−02 | −3.6134E−02 | 2.2198E−02 | 2.7115E−02 | 1.5989E−02 |
| α₄ | 1.3445E−02 | 5.9783E−03 | −1.0830E−02 | −2.7336E−03 | −2.9951E−03 |
| α₅ | 2.2898E−02 | −1.8707E−03 | 3.5027E−03 | −2.6215E−05 | 3.0082E−04 |
| α₆ | −1.3001E−02 | −1.6124E−04 | −3.4385E−04 | 2.2851E−05 | −1.9067E−05 |
| α₇ | −1.1091E−02 | 4.3226E−04 | −1.0518E−04 | −1.2019E−06 | 8.2203E−07 |
| α₈ | 1.5029E−02 | −4.3787E−05 | 1.9582E−05 | 3.4977E−09 | −1.6587E−08 |

TABLE 7
(the third preferred embodiment)

| | Surface | | | | |
|---|---|---|---|---|---|
| | S2 | S3 | S4 | S5 | S6 |
| k | 3.9150E−01 | 0.0000E+00 | 0.0000E+00 | −2.4546E+00 | 0.0000E+00 |
| α₂ | −5.7779E−03 | 1.6991E−02 | −3.9016E−02 | −8.3681E−03 | −7.8950E−02 |
| α₃ | 2.3351E−02 | 2.1196E−02 | 8.3384E−02 | 1.3016E−01 | −4.5572E−02 |
| α₄ | −5.4221E−02 | 1.0720E−02 | −7.1320E−02 | −1.6012E−01 | 1.3647E−02 |
| α₅ | 6.8898E−02 | 5.2705E−03 | −2.2895E−02 | 1.1730E−01 | 5.7308E−02 |
| α₆ | 2.0136E−02 | −6.8084E−02 | 5.3150E−02 | 1.0781E−01 | −1.1311E−02 |
| α₇ | −9.6963E−02 | 8.5647E−02 | −2.1844E−02 | −2.1746E−01 | −8.6087E−02 |
| α₈ | 6.4042E−02 | −2.3459E−02 | −2.1584E−02 | 1.1272E−01 | 1.0250E−01 |
| | Surface | | | | |
| | S7 | S8 | S9 | S10 | S11 |
| k | 0.0000E+00 | 0.0000E+00 | −3.7647E+00 | 0.0000E+00 | −7.5586E+00 |
| α₂ | −4.8208E−02 | 4.1265E−02 | −1.2769E−02 | −9.4499E−02 | −5.5702E−02 |
| α₃ | −6.0929E−02 | −3.6661E−02 | 2.1955E−02 | 2.7143E−02 | 1.4914E−02 |
| α₄ | 1.3597E−02 | 5.0974E−03 | −1.0931E−02 | −2.7193E−03 | −2.9782E−03 |
| α₅ | 2.4117E−02 | −2.2340E−03 | 3.4853E−03 | −2.4300E−05 | 3.0673E−04 |
| α₆ | −1.1592E−02 | −2.2083E−04 | −3.4607E−04 | 2.3050E−05 | −1.8865E−05 |
| α₇ | −1.2502E−02 | 4.5259E−04 | −1.0511E−04 | −1.1879E−06 | 8.0303E−07 |
| α₈ | 1.4936E−02 | −1.9849E−05 | 1.9798E−05 | 2.7928E−09 | −1.6311E−08 |

TABLE 8
(the fourth preferred embodiment)

| | Surface | | | | |
|---|---|---|---|---|---|
| | S2 | S3 | S4 | S5 | S6 |
| k | −3.8209E−01 | 1.6118E+02 | 2.0466E+01 | −4.3611E+00 | −2.5190E+02 |
| α₂ | 7.7357E−03 | −4.4202E−02 | −1.0889E−01 | −4.8835E−02 | −9.1648E−02 |
| α₃ | 8.5634E−02 | 1.1795E−01 | 1.5684E−01 | 1.4657E−01 | −4.0292E−02 |
| α₄ | −1.8319E−01 | −1.3045E−01 | −7.3319E−02 | −1.6265E−01 | −3.5119E−02 |
| α₅ | 2.0437E−01 | 1.3145E−01 | −1.0495E−01 | 7.2527E−02 | 1.0417E−01 |
| α₆ | −1.3526E−02 | −1.2661E−01 | 1.2278E−01 | 1.2177E−01 | −4.8535E−02 |
| α₇ | −1.1899E−01 | 8.5146E−02 | −2.1900E−02 | −2.1847E−01 | −9.9189E−02 |
| α₈ | 6.3988E−02 | −2.3943E−02 | −2.2200E−02 | 1.1218E−01 | 1.0482E−01 |
| | Surface | | | | |
| | S7 | S8 | S9 | S10 | S11 |
| k | −9.5723E+00 | −2.0817E+00 | −3.7930E+00 | 4.1990E+00 | −7.9121E+00 |
| α₂ | −5.6683E−02 | 2.8871E−02 | −2.9847E−02 | −7.0513E−02 | −5.0001E−02 |
| α₃ | −3.9870E−02 | −2.3823E−02 | 3.1231E−02 | 2.2607E−02 | 1.3518E−02 |
| α₄ | −2.2895E−02 | 4.0957E−03 | −1.3362E−02 | −2.4760E−03 | −2.5504E−03 |
| α₅ | 5.0332E−02 | −2.2113E−03 | 3.4118E−03 | 8.1762E−06 | 2.7500E−04 |
| α₆ | −1.9482E−02 | −1.5640E−04 | −2.5116E−04 | 2.1380E−05 | −2.0579E−05 |
| α₇ | −2.1199E−02 | 4.4321E−04 | −8.2305E−05 | −1.7150E−06 | 1.1779E−06 |
| α₈ | 2.0366E−02 | −6.0892E−05 | 1.3067E−05 | 4.1424E−08 | −3.4018E−08 |

In addition, with the aperture ST and the aforementioned aspheric design for the lenses L1-L5, the problem of distortion which tends to happen in wide angle optical design can be effectively fixed. Moreover, the first lens L1 is made of glass, and through the arrangement of diopters of the lenses L1-L5 as positive, negative, positive, positive, and negative, the imaging lenses 1-4 can provide high imaging quality, which effectively achieves the purpose of getting miniature size, providing wide angle, and eliminating optical distortion. Specifically, the imaging lenses 1-4 satisfy the following rules:

60≦Vd1; (1)

0.74≦f1/f≦0.85; (2)

−1.6≦f2/f≦−1.3; (3)

3.8≦f3/f≦5.1; (4)

0.75≦f4/f≦0.96; (5)

−0.70≦f5/f≦−0.54; (6)

1.16≦TTL/f≦1.20; (7)

0.69≦IMH/TTL≦0.78; (8)

1.9≦f1/R1≦2.2; (9)

where, Vd1 is the Abbe number of the first lens L1; R1 is the radius of curvature of the surface S2 of the first lens L1, which faces the object side, at where the optical axis passes through; f is the focal length of the imaging lenses 1-4; f1 is the focal length of the first lens L1; f2 is the focal length of the second lens L2; f3 is the focal length of the third lens L3; f4 is the focal length of the fourth lens L4; f5 is the focal length of the fifth lens L5; IMH is a height of the imaging plane of the imaging lenses 1-4; TTL is a total length of the imaging lenses 1-4.

When rules (1) to (3) are satisfied, field curvature of each of the imaging lenses 1-4 can be significantly improved; when rules (4) to (6) are satisfied, peripheral distortion, chromatic difference of magnification, and spherical aberration can be effectively eliminated. In addition, with the aspheric shape of the fifth lens L5, the light passing through the periphery of the fifth lens L5 is effectively suppressed, and therefore the incidence angle is reduced, which eases the melange effect happens due to large incidence angle. When rules (7) to (9) are satisfied, the total length of the imaging lenses 1-4 can be greatly shortened. In other words, if the above rules are not satisfied, the problem of poor chromatic difference of magnification and low imaging quality would arise; furthermore, the size of the lens cannot be miniature either.

The detailed figures of the imaging lenses 1-4 of the first to the fourth preferred embodiments of the present invention are listed in Table 9.

TABLE 9

| | First | Second | Third | Fourth |
|---|---|---|---|---|
| | Preferred | Preferred | Preferred | Preferred |
| | Embodiment | Embodiment | Embodiment | Embodiment |
| f | 4.6 | 4.08 | 4.13 | 4.2 |
| TTL | 5.4 | 4.78 | 4.8 | 5 |
| IMH | 3.775 | 3.7 | 3.53 | 3.7 |
| f1 | 3.418 | 3.14 | 3.16 | 3.54 |
| f2 | −6.382 | −5.66 | −5.54 | −6.58 |
| f3 | 23.15 | 18.26 | 17.65 | 16.14 |
| f4 | 3.96 | 3.16 | 3.93 | 3.16 |
| f5 | −2.845 | −2.31 | −2.85 | −2.29 |
| R1 | 1.713 | 1.515 | 1.53 | 1.63 |
| Vd1 | 64.1 | 64.1 | 64.1 | 63.3 |
| f1/f | 0.743 | 0.769 | 0.765 | 0.842 |
| f2/f | −1.387 | −1.387 | −1.341 | −1.566 |
| f3/f | 5.032 | 4.475 | 4.273 | 3.842 |
| f4/f | 0.860 | 0.774 | 0.951 | 0.752 |
| f5/f | −0.618 | −0.566 | −0.690 | −0.545 |
| TTL/f | 1.173 | 1.171 | 1.162 | 1.190 |
| IMH/TTL | 0.699 | 0.7747 | 0.735 | 0.740 |
| f1/R | 1.995 | 2.072 | 2.065 | 2.171 |

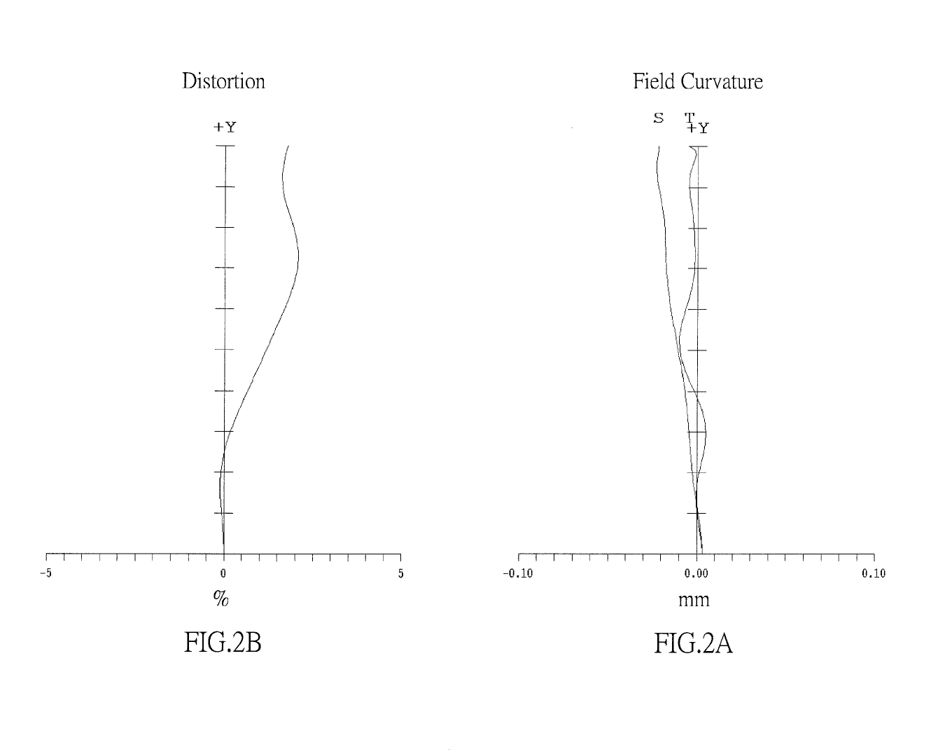

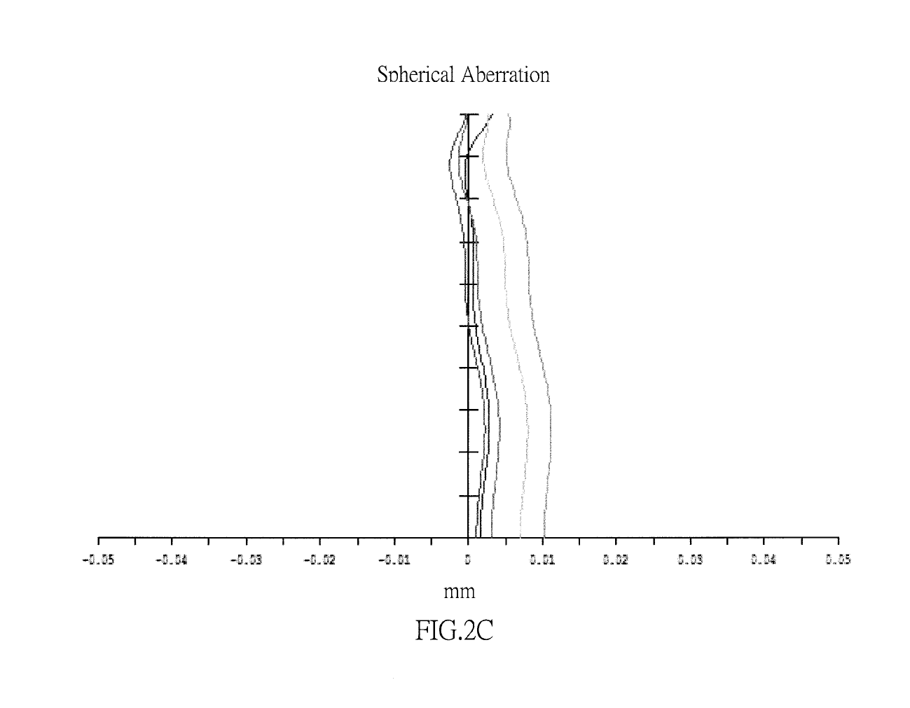

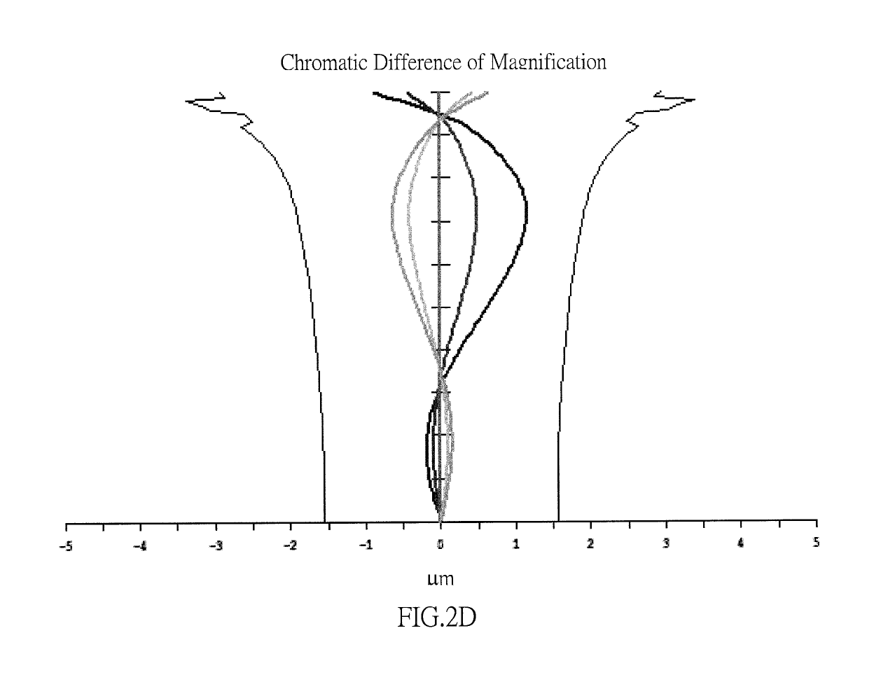

As shown in FIG. 2A to 2D, the imaging lens 1 of the first preferred embodiment of the present invention is able to provide high imaging quality, wherein the maximum field curvature of the imaging lens 1 does not exceed −0.03 mm and 0.01 mm, which can be seen in FIG. 2A; the maximum distortion of the imaging lens 1 does not exceed −0.5% and 2.5%, which can be seen in FIG. 2B; the spherical aberration of the imaging lens 1 does not exceed −0.005 mm and 0.015 mm, which can be seen in FIG. 2C; the chromatic difference of magnification of the imaging lens 1 does not exceed −1 μm and 1.5 nm, which can be seen in FIG. 2D. In other words, the imaging lens 1 provides high optical performance.

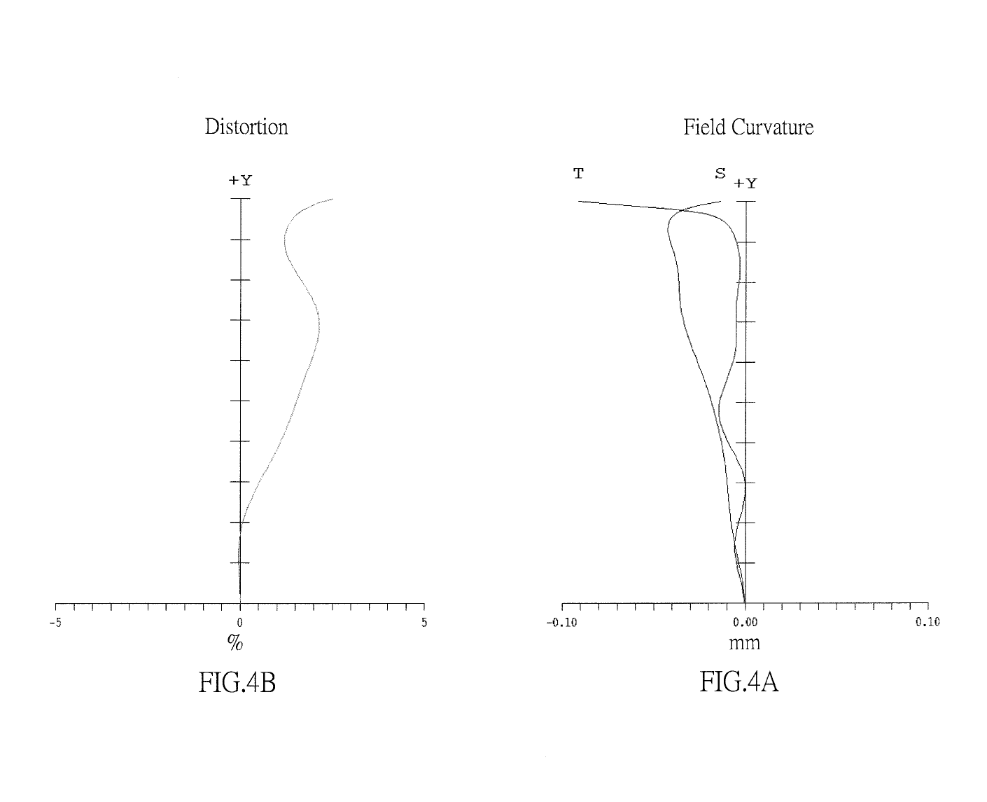

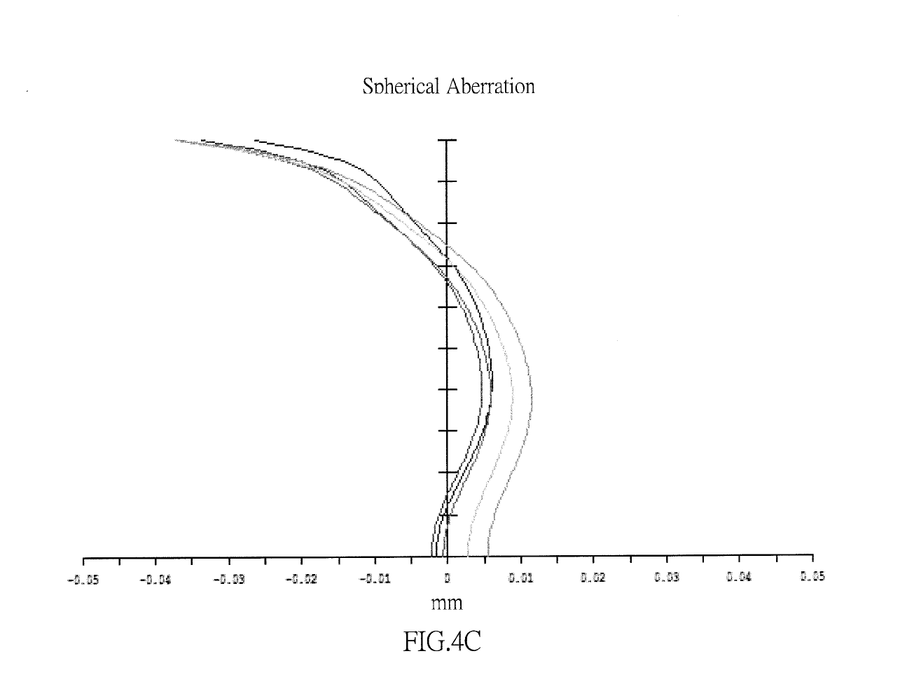

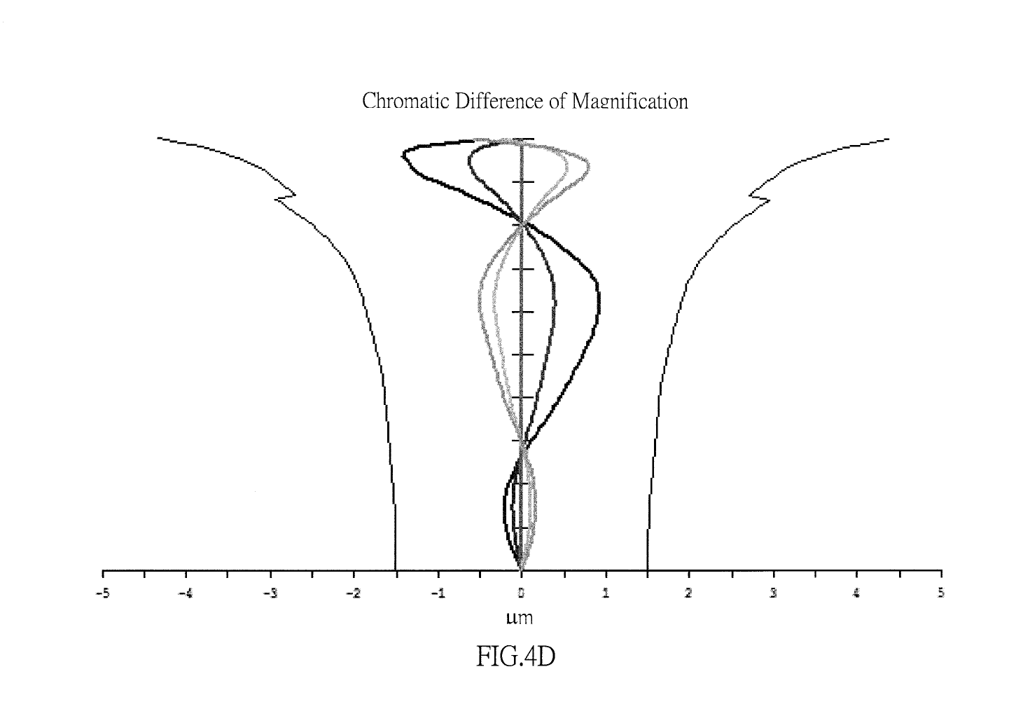

Similarly, as shown in FIG. 4A to 4D, the imaging lens 2 of the second preferred embodiment of the present invention is also able to provide high imaging quality, wherein the maximum field curvature of the imaging lens 2 does not exceed −0.01 mm and 0 mm, which can be seen in FIG. 4A; the maximum distortion of the imaging lens 2 does not exceed 0.5% and 2.5%, which can be seen in FIG. 4B; the spherical aberration of the imaging lens 2 does not exceed −0.04 mm and 0.015 mm, which can be seen in FIG. 4C; the chromatic difference of magnification of the imaging lens 2 does not exceed −1.5 nm and 1 μm, which can be seen in FIG. 4D. In other words, the imaging lens 2 provides high optical performance.

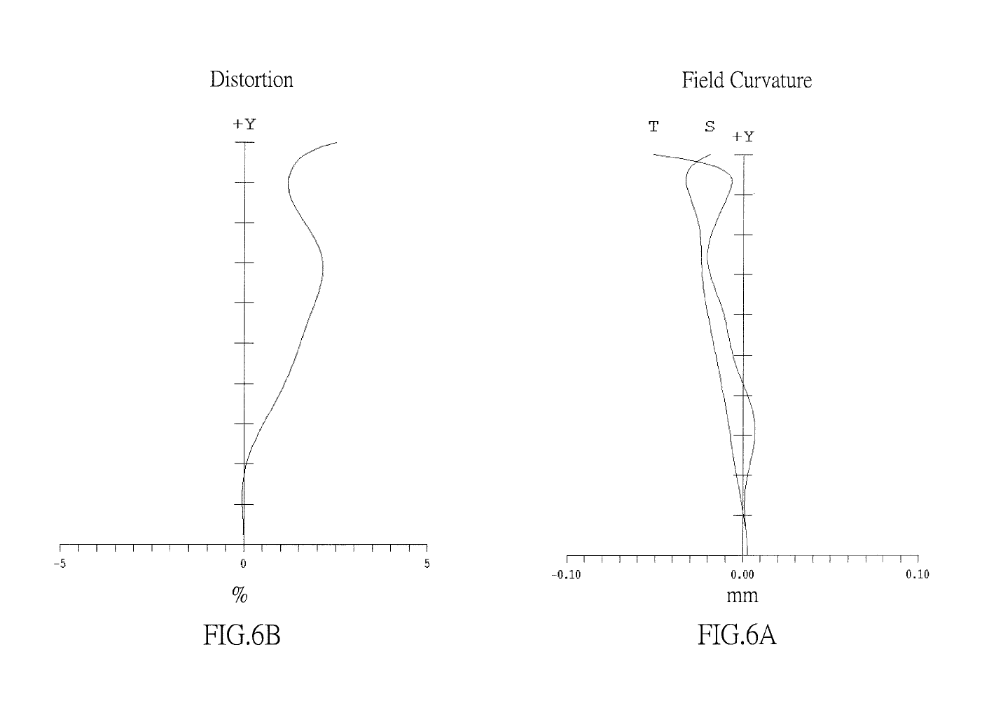

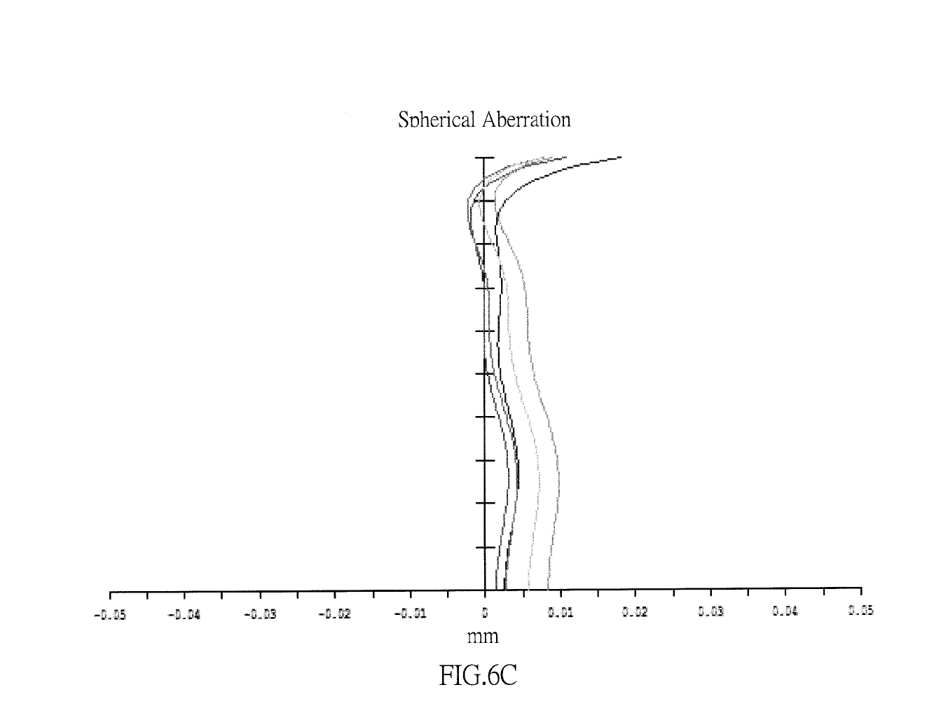

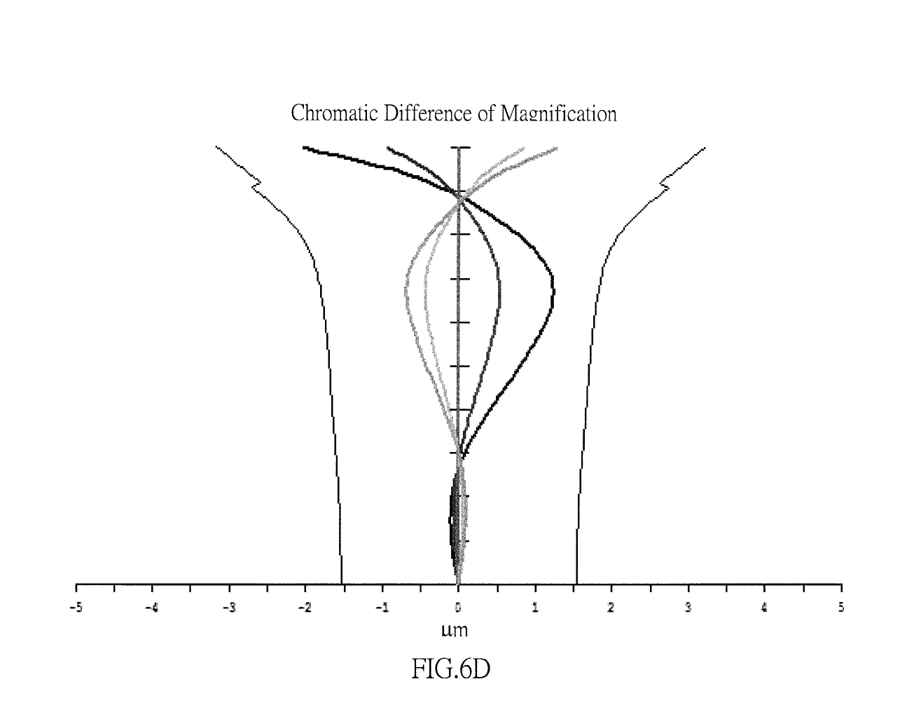

In addition, as shown in FIG. 6A to 6D, the imaging lens 3 of the third preferred embodiment of the present invention is also able to provide high imaging quality, wherein the maximum field curvature of the imaging lens 3 does not exceed −0.06 mm and 0.01 mm, which can be seen in FIG. 6A; the maximum distortion of the imaging lens 3 does not exceed 0% and 3%, which can be seen in FIG. 6B; the spherical aberration of the imaging lens 3 does not exceed −0.005 mm and 0.02 mm, which can be seen in FIG. 6C; the chromatic difference of magnification of the imaging lens 3 does not exceed −2.5 nm and 1.5 nm, which can be seen in FIG. 6D. In other words, the imaging lens 3 provides high optical performance.

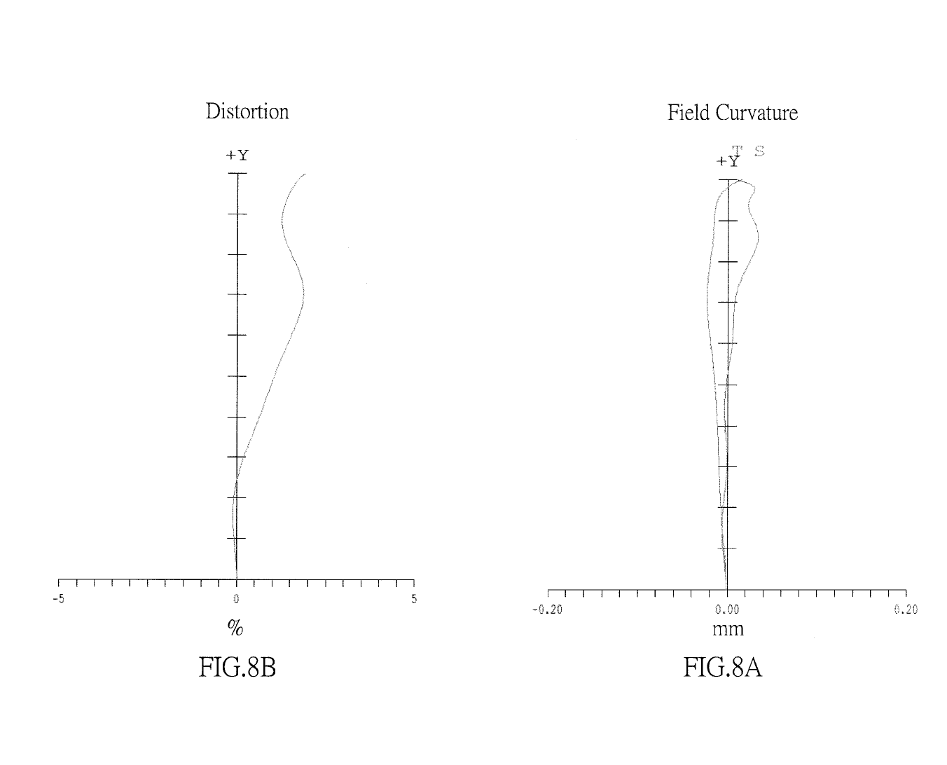

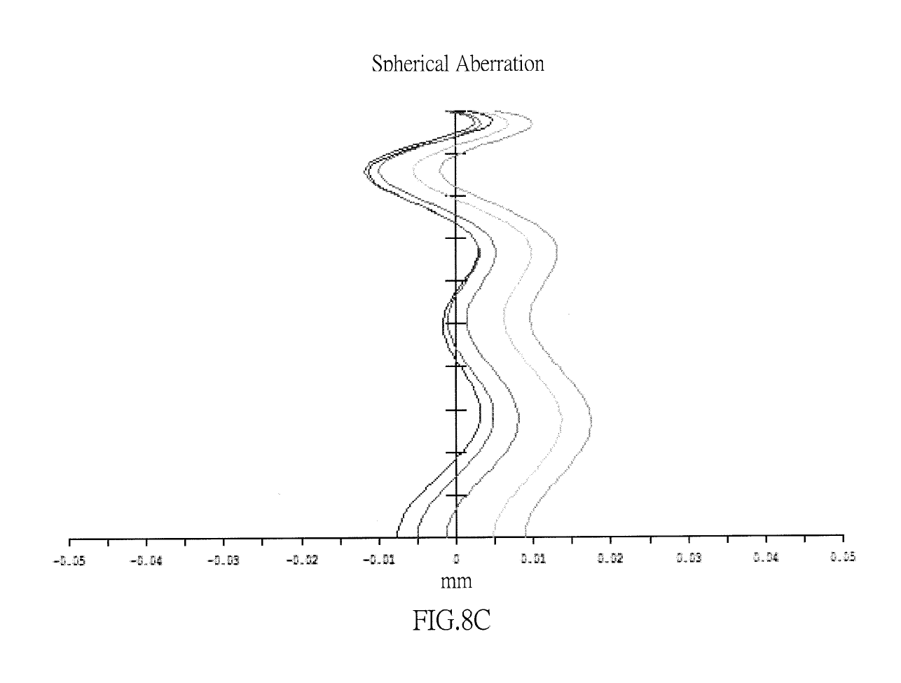

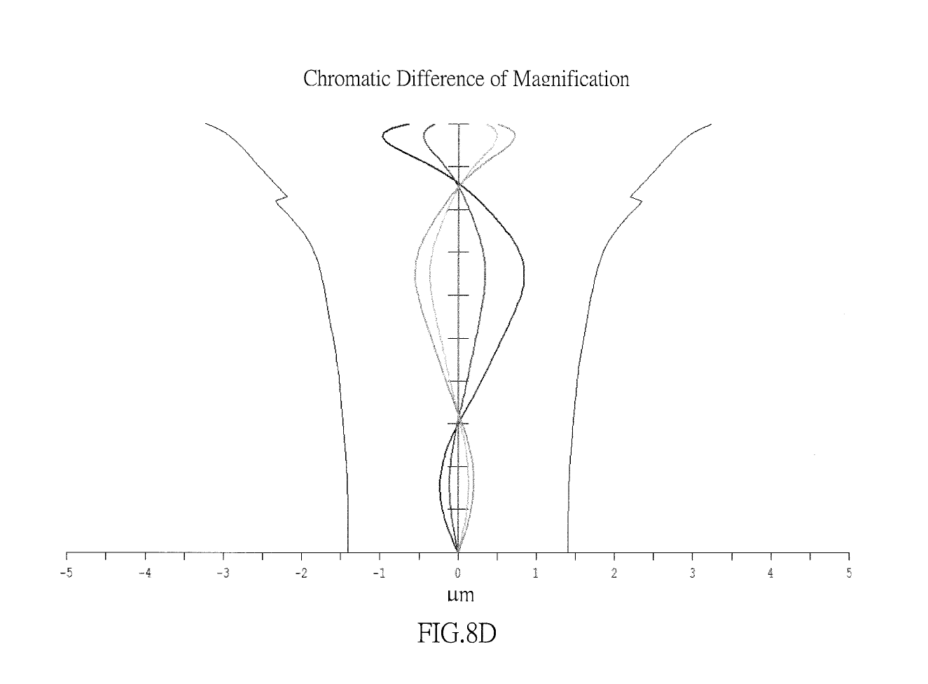

Finally, as shown in FIG. 8A to 8D, the imaging lens 4 of the fourth preferred embodiment of the present invention is also able to provide high imaging quality, wherein the maximum field curvature of the imaging lens 4 does not exceed −0.04 mm and 0.04 mm, which can be seen in FIG. 8A; the maximum distortion of the imaging lens 4 does not exceed 0.5% and 2%, which can be seen in FIG. 8B; the spherical aberration of the imaging lens 4 does not exceed −0.015 mm and 0.02 mm, which can be seen in FIG. 8C; the chromatic difference of magnification of the imaging lens 4 does not exceed −1 μm and 1 μm, which can be seen in FIG. 8D. In other words, the imaging lens 4 also provides high optical performance.

In summary, with the imaging lenses 1-4 provided in the present invention, the purpose of getting miniature size and high optical performance can be effectively achieved. In addition, the visible angle of a wide angle system which uses any of the imaging lenses 1-4 can be broadened.

It must be pointed out that the embodiments described above are only some preferred embodiments of the present invention. All equivalent structures which employ the concepts disclosed in this specification and the appended claims should fall within the scope of the present invention.

What is claimed is:

1. An imaging lens, in order from an object side to an image side along an optical axis, comprising:
an aperture;
a first lens made of glass, which is a positive meniscus lens, wherein a convex surface thereof faces the object side, and a concave surface thereof faces the image side; at least one of the surfaces of the first lens is aspheric; an Abbe number of first lens is no less than 60;
a second lens made of plastic, which is a negative meniscus lens, wherein a convex surface thereof faces the object side, and a concave surface thereof faces the image side; at least one of the surfaces of the second lens is aspheric;
a third lens made of plastic, which is a positive meniscus lens, wherein a convex surface thereof faces the image side, and a concave surface thereof faces the object side; at least one of the surfaces of the third lens is aspheric;
a fourth lens made of plastic, which is a positive meniscus lens, wherein a convex surface thereof faces the image side, and a concave surface thereof faces the object side; at least one of the surfaces of the fourth lens is aspheric;
a fifth lens made of plastic, wherein both surfaces of the fifth lens are aspheric; a diopter of the fifth lens gradually turns from negative to positive from where the optical axis passes through to a margin of the fifth lens.

2. The imaging lens of claim 1, wherein the surfaces of the first lens are both aspheric.

3. The imaging lens of claim 1, wherein the surfaces of the second lens are both aspheric.

4. The imaging lens of claim 1, wherein the surfaces of the third lens are both aspheric.

5. The imaging lens of claim 1, wherein the surfaces of the fourth lens are both aspheric.

6. The imaging lens of claim 1, wherein the surface of the fifth lens which faces the object side is concave at where the optical axis passes through.

7. The imaging lens of claim 6, wherein a radius of curvature of the surface of the fifth lens which faces the object side is negative at where the optical axis passes through, and gradually turns from negative to positive from where the optical axis passes through to the margin of the fifth lens.

8. The imaging lens of claim 1, wherein the surface of the fifth lens which faces the object side is convex at where the optical axis passes through.

9. The imaging lens of claim 8, wherein a radius of curvature of the surface of the fifth lens which faces the object side is positive at where the optical axis passes through, and gradually turns from positive to negative and positive again from where the optical axis passes through to the margin of the fifth lens.

10. The imaging lens of claim 1, wherein a surface of the fifth lens which faces the image side is concave at where the optical axis passes through.

11. The imaging lens of claim 10, wherein a radius of curvature of the surface of the fifth lens which faces the image side is p positive at where the optical axis passes through, and the radius of curvature gradually turns from positive to negative from where the optical axis passes through to the margin of the fifth lens.

12. The imaging lens of claim 1, further satisfying:
0.74≦f1/f≦0.85;
where f1 is a focal length of the first lens; f is a focal length of the imaging lens.

13. The imaging lens of claim 1, further satisfying:
−1.6≦f2/f≦−1.3;
where f2 is a focal length of the second lens; f is a focal length of the imaging lens (1, 2, 3, 4).

14. The imaging lens of claim 1, further satisfying:
3.8≦f3/f≦5.1;
where f3 is a focal length of the third lens; f is a focal length of the imaging lens.

15. The imaging lens of claim 1, further satisfying:
0.75≦f4/f≦0.96;
where f4 is a focal length of the fourth lens; f is a focal length of the imaging lens.

16. The imaging lens of claim 1, further satisfying:
−0.70≦f5/f≦−0.54;
where f5 is a focal length of the fifth lens; f is a focal length of the imaging lens.

17. The imaging lens of claim 1, further satisfying:
1.16≦TTL/f≦1.20;
where f is a focal length of the imaging lens; TTL is a total length of the image lens.

18. The imaging lens of claim 1, further satisfying:
0.69≦IMH/TTL≦0.78;
where IMH is a height of an imaging plane of the imaging lens; TTL is a total length of the image lens.

19. The imaging lens of claim 1, further satisfying:
1.9≦f1/R1≦2.2;
where f1 is a focal length of the first lens; R1 is a radius of curvature of the surface of the first lens which faces the object side at where the optical axis passes through.
